(19) United States
(12) Patent Application Publication
(10) Pub. No.: US 2011/0032333 A1
(43) Pub. Date: Feb. 10, 2011

(54) METHOD AND SYSTEM FOR 3D VIDEO FORMAT CONVERSION WITH INVERSE TELECINE

(76) Inventors: Darren Neuman, Palo Alto, CA (US); Xuemin Chen, Rancho Santa Fe, CA (US); Chris Payson, Bolton, MA (US); Jason Herrick, Pleasanton, CA (US); Val (Shawn) Johnson, Rancho Santa Margarita, CA (US)

Correspondence Address: MCANDREWS HELD & MALLOY, LTD, 500 WEST MADISON STREET, SUITE 3400, CHICAGO, IL, 60661, US

(21) Appl. No.: 12/851,095

(22) Filed: Aug. 5, 2010

Related U.S. Application Data
(60) Provisional application No. 61/232,123, filed on Aug. 7, 2009.

(51) Int. Cl. H04N 15/00

(52) U.S. Cl. 348/43; 348/E15.001

(57) ABSTRACT

A 3-dimensional (3D) video receiver may be operable to convert a decompressed 3D video frame having a 3D video interlaced format to generate a first 3D video frame having a first 3D video progressive format by performing an inverse pulldown. The generated first 3D video frame having the first 3D video progressive format may be converted to generate a second 3D video frame having a second 3D video progressive format. The generated first 3D video frame having the first 3D video progressive format may be scaled to generate the second 3D video frame having the second 3D video progressive format. When the 3D video receiver is operating in an electronic program guide (EPG) mode or in a graphics over video mode, the generated second 3D video frame having the second 3D video progressive format may be blended with graphics.

### CROSS-REFERENCE TO RELATED APPLICATIONS/INCORPORATION BY REFERENCE

This patent application makes reference to, claims priority to, and claims benefit from U.S. Provisional Application Ser. No. 61/232,123, which was filed on Aug. 7, 2009.

This application also makes reference to:

U.S. patent application Ser. No. ______ (Attorney Docket No. 20914U502) filed on; and
U.S. patent application Ser. No. ______ (Attorney Docket No. 23642U502) filed on

Each of the above stated applications is hereby incorporated herein by reference in its entirety.

### FIELD OF THE INVENTION

Certain embodiments of the invention relate to video processing. More specifically, certain embodiments of the invention relate to a method and system for 3D video format conversion with inverse telecine.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV (DTV), a 3D video is often desirable because it is often more realistic to viewers than the 2D counterpart. A 3D video comprises a left view video and a right view video. A 3D video frame may be produced by combining left view video components and right view video components.

Various video encoding standards, for example, MPEG-1, MPEG-2, MPEG-4, H.263, H.264/MPEG-4 advanced video coding (AVC) and multi-view video coding (MVC), have been established for encoding digital video sequences in a compressed manner. For example, the MVC standard, which is an extension of the H.264/MPEG-4 AVC standard, may be used to encode a 3D video.

Most TV broadcasts, and similar multimedia feeds, utilize video formatting standard that enable communication of video images in the form of bitstreams. These video standards may utilize various interpolation and/or rate conversion functions to present content comprising still and/or moving images on display devices. For example, deinterlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for 3D video format conversion with inverse telecine, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating exemplary 3D video formats, in accordance with an embodiment of the invention.

FIG. 2 is a block diagram illustrating an exemplary video communication system that is operable to provide 3D video format conversion with inverse telecine, in accordance with an embodiment of the invention.

FIG. 3 is a block diagram illustrating an exemplary 3D video receiver that is operable to provide 3D video format conversion with inverse telecine, in accordance with an embodiment of the invention.

FIG. 4 is an exemplary table that illustrates 3D video format conversion performed by a 3D video receiver, in accordance with an embodiment of the invention.

FIG. 5 is a flow chart illustrating exemplary steps for 3D video format conversion with inverse telecine, in accordance with an embodiment of the invention.

### DETAILED DESCRIPTION OF THE INVENTION

Certain embodiments of the invention can be found in a method and system for 3D video format conversion with inverse telecine. In various embodiments of the invention, a 3-dimensional (3D) video receiver may be operable to convert a decompressed 3D video frame having a 3D video interlaced format to generate a first 3D video frame having a first 3D video progressive format by performing an inverse pulldown. The generated first 3D video frame having the first 3D video progressive format may be converted by the 3D video receiver to generate a second 3D video frame having a second 3D video progressive format. In this regard, the 3D video receiver may be operable to scale the generated first 3D video frame having the first 3D video progressive format to generate the second 3D video frame having the second 3D video progressive format.

In an exemplary embodiment of the invention, the 3D video receiver may be operable to determine when the 3D video receiver may be operating in film mode. In the film mode, the 3D video interlaced format of the decompressed 3D video frame may be derived using pulldown. In instances when the 3D video receiver is operating in the film mode, the 3D video receiver may be operable to convert the decompressed 3D video frame having the 3D video interlaced format, which may comprise a 60 Hz field rate, to generate the first 3D video frame having the first 3D video progressive format, which may comprise a 24 Hz frame rate, by performing an inverse 3:2 pulldown. The 3D video receiver may be operable to convert the decompressed 3D video frame having the 3D video interlaced format, which may comprise a 50 Hz field rate, to generate the first 3D video frame having the first 3D video progressive format, which may comprise a 24 Hz frame rate, by performing an inverse 2:2 pulldown. In this regard, for example, the decompressed 3D video frame having side-by-side (half) 1080i60 format may be converted by the 3D video receiver to generate the first 3D video frame having side-by-side (half) 1080p24 format by performing an inverse 3:2 pulldown. The decompressed 3D video frame having side-by-side (half) 1080i50 format may be converted by the 3D video receiver to generate the first 3D video frame having side-by-side (half) 1080p24 format by performing an inverse 2:2 pulldown. In such instances, the generated first 3D video frame having the side-by-side (half) 1080p24 format may be scaled by the 3D video receiver to generate the second 3D video frame having frame packing 1080p24 format, for example.

In an exemplary embodiment of the invention, the 3D video receiver may be operable to determine when the 3D video receiver may be operating in an EPG mode or in a graphics over video mode. In instances when the 3D video receiver is operating in the EPG mode or in the graphics over video mode, the generated second 3D video frame having the second 3D video progressive format may be blended with graphics by the 3D video receiver. In this regard, in instances when the graphics may comprise 3D graphics, a depth of the 3D graphics and/or a depth of the generated second 3D video frame may be adjusted coordinately by the 3D video receiver for a blended frame to provide better overall depth of the blended frame.

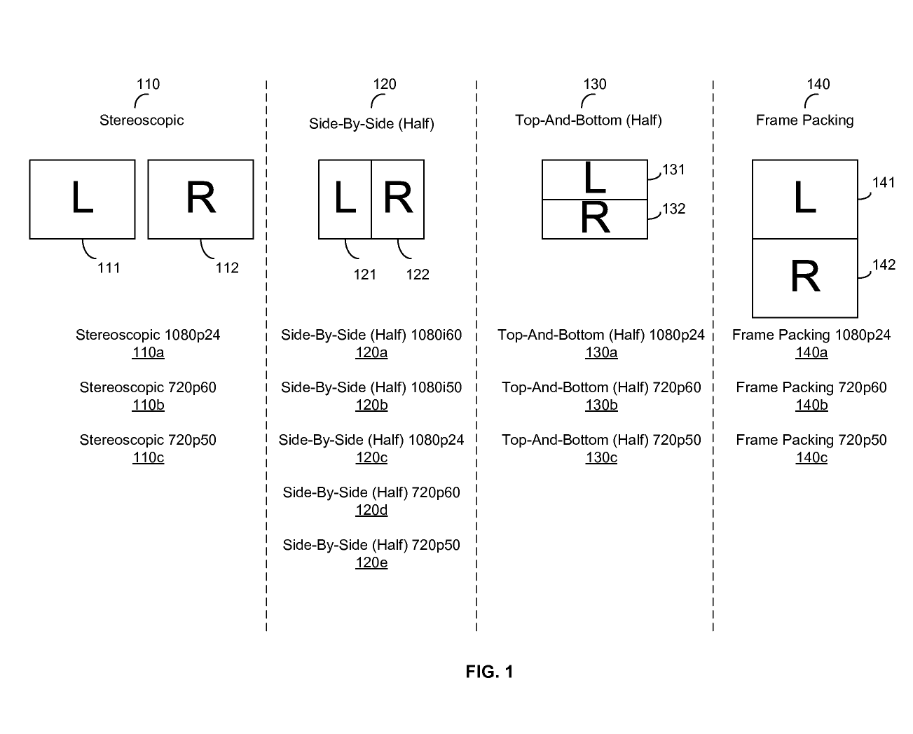

FIG. 1 is a block diagram illustrating exemplary 3D video formats, in accordance with an embodiment of the invention. Referring to FIG. 1, there is shown a stereoscopic format 110, a side-by-side (half) format 120, a top-and-bottom (half) format 130 and a frame packing format 140.

A 3D video in the stereoscopic format 110 may comprise a full resolution left view frame 111 and a full resolution right view frame 112. The stereoscopic format 110 may comprise, for example, stereoscopic 1080p24 format 110a, stereoscopic 720p60 format 110b and/or stereoscopic 720p50 format 110c.

A 3D video in the side-by-side (half) format 120 may comprise a half resolution left view 121 and a half resolution right view 122, which may be packed as side-by-side or left-and-right in a frame. The side-by-side (half) format 120 may comprise, for example, side-by-side (half) 1080i60 format 120a, side-by-side (half) 1080i50 format 120b, side-by-side (half) 1080p24 format 120c, side-by-side (half) 720p60 format 120d and/or side-by-side (half) 720p50 format 120e.

A 3D video in the top-and-bottom (half) format 130 may comprise a half resolution left view 131 and a half resolution right view 132, which may be packed as top-and-bottom in a frame. The top-and-bottom (half) format 130 may comprise, for example, top-and-bottom (half) 1080p24 format 130a, top-and-bottom (half) 720p60 format 130b and/or top-and-bottom (half) 720p50 format 130c.

A 3D video in the frame packing format 140 may comprise a full resolution left view 141 and a full resolution right view 142, which may be packed as top-and-bottom in a frame with twice the normal bandwidth. The frame packing format 140 is a full resolution top-and-bottom format. The frame packing format 140 may comprise, for example, frame packing 1080p24 format 140a, frame packing 720p60 format 140b and/or frame packing 720p50 format 140c.

A 3D video frame in a 1080i60 format, such as the side-by-side (half) 1080i60 format 120a, may comprise a resolution of 1920×1080 pixels in interlace mode at a 60 Hz field rate. In this regard, for example, a left view 121 or a right view 122 in the side-by-side (half) 1080i60 format 120a may comprise a resolution of 960×1080 pixels. A 3D video frame in a 1080i50 format, such as the side-by-side (half) 1080i50 format 120b, may comprise a resolution of 1920×1080 pixels in interlace mode at a 50 Hz field rate. In this regard, for example, a left view 121 or a right view 122 in the side-by-side (half) 1080i50 format 120b may comprise a resolution of 960×1080 pixels.

A 3D video frame in a 1080p24 format, such as the stereoscopic 1080p24 format 110a, the side-by-side (half) 1080p24 format 120c, the top-and-bottom (half) 1080p24 format 130a or the frame packing 1080p24 format 140a, may comprise a resolution of 1920×1080 pixels in progressive scan mode at a 24 Hz frame rate. In this regard, for example, a left view 121 or a right view 122 in the side-by-side (half) 1080p24 format 120c may comprise a resolution of 960×1080 pixels. A left view 131 or a right view 132 in the top-and-bottom (half) 1080p24 format 130a may comprise a resolution of 1920×540 pixels. A left view 141 or a right view 142 in the frame packing 1080p24 format 140a may comprise a resolution of 1920×1080 pixels.

A 3D video frame in a 720p60 format, such as the stereoscopic 720p60 format 110b, the side-by-side (half) 720p60 format 120d, the top-and-bottom (half) 720p60 format 130b or the frame packing 720p60 format 140b, may comprise a resolution of 1280×720 pixels in progressive scan mode at a 60 Hz frame rate. In this regard, for example, a left view 121 or a right view 122 in the side-by-side (half) 720p60 format 120d may comprise a resolution of 640×720 pixels. A left view 131 or a right view 132 in the top-and-bottom (half) 720p60 format 130b may comprise a resolution of 1280×360 pixels. A left view 141 or a right view 142 in the frame packing 720p60 format 140b may comprise a resolution of 1280×720 pixels.

A 3D video frame in a 720p50 format, such as the stereoscopic 720p50 format 110c, the side-by-side (half) 720p50 format 120e, the top-and-bottom (half) 720p50 format 130c or the frame packing 720p50 format 140c, may comprise a resolution of 1280×720 pixels in progressive scan mode at a 50 Hz frame rate. In this regard, for example, a left view 121 or a right view 122 in the side-by-side (half) 720p50 format 120e may comprise a resolution of 640×720 pixels. A left view 131 or a right view 132 in the top-and-bottom (half) 720p50 format 130c may comprise a resolution of 1280×360 pixels. A left view 141 or a right view 142 in the frame packing 720p50 format 140c may comprise a resolution of 1280×720 pixels.

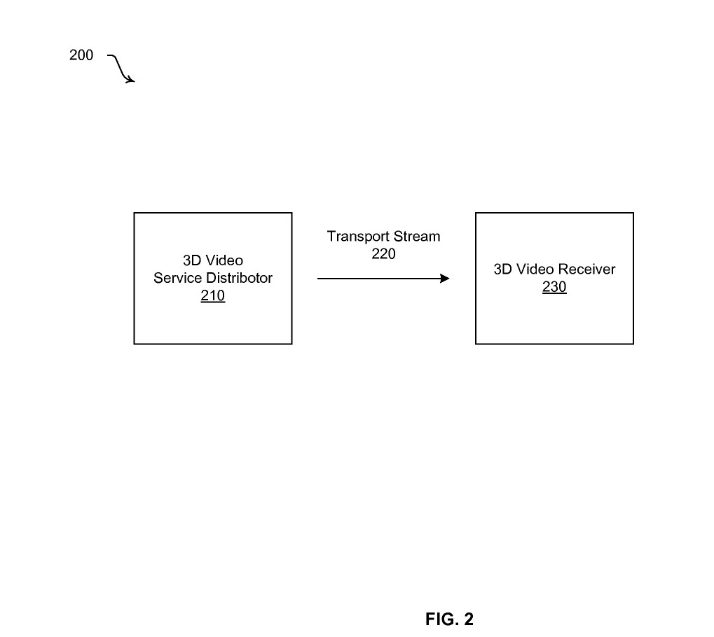

FIG. 2 is a block diagram illustrating an exemplary video communication system that is operable to provide 3D video format conversion, in accordance with an embodiment of the invention. Referring to FIG. 2, there is shown a video communication system 200. The video communication system 200 may comprise a 3D video service distributor 210, a transport stream 220 and a 3D video receiver 230.

The 3D video service distributor 210 may comprise suitable logic, circuitry, interfaces and/or code that may be operable to distribute 3D video content to the 3D video receiver 230 via a bitstream such as the transport stream 220. The 3D service distributor 210 such as, for example, a headend system may be operable to provide various services such as, for example, distribution, multicast, and/or quality of service necessary for a reliable and timely transmission of 3D video content to the 3D video receiver 230. The 3D service distributor 210 may utilize, for example, a cable TV network, a satellite broadcasting network, the Internet protocol (IP) data network such as the Internet, and/or a wireless communication network for delivery of services or 3D video content to the 3D video receiver 230. The 3D video may be encoded or compressed using a MVC method and transmitted to the 3D video receiver 230 via the transport stream 220, for example.

The 3D video receiver 230 may comprise suitable logic, circuitry, interfaces and/or code that may be operable to receive the compressed 3D video via a bitstream such as the transport stream 220 from the 3D video service distributor 210. The 3D video receiver 230 may decode or decompress the received compressed 3D video into a decompressed 3D video. The 3D video receiver 230 may be, for example, a STB and/or a DTV set. In an exemplary embodiment of the invention, a 3D video receiver 230 such as the DTV set may be operable to receive a decompressed 3D video from other 3D video receiver such as the STB, via, for example, a high-definition multimedia interface (HDMI) connection.

In operation, the 3D video receiver 230 may be operable to convert a decompressed 3D video frame, which may have a 3D video interlaced format, to generate a first 3D video frame, which may have a first 3D video progressive format, by performing an inverse pulldown. The generated first 3D video frame having the first 3D video progressive format may be scaled by the 3D video receiver 230 to generate a second 3D video frame, which may have a second 3D video progressive format. The decompressed 3D video frame may comprise, for example, a MVC decompressed 3D video frame.

The pulldown is a telecine process which may convert a progressive video frame at a frame rate to an interlaced video frame at different frame rate. The pulldown may comprise 3:2 pulldown or 2:2 pulldown. For example, a 1080p24 format may be converted to a 1080i60 format by performing a 3:2 pulldown. A 1080p24 format may be converted to a 1080i50 format by performing a 2:2 pulldown. When the 3D video receiver 230 is operating in film mode, the 3D video interlaced format of the decompressed 3D video frame may be derived using a pulldown. In this regard, for example, a 1080i60 format of the decompressed 3D video frame may be derived using the 3:2 pulldown, and a 1080i50 format of the decompressed 3D video frame may be derived using the 2:2 pulldown.

The inverse pulldown, which is a reversed process of the pulldown, is an inverse telecine process that may convert an interlaced video frame at a frame rate to a progressive video frame at different frame rate. For example, when a 3D video receiver 230 is operating in film mode, a 1080i60 format of the decompressed 3D video frame may be converted to a 1080p24 format by performing an inverse 3:2 pulldown, and a 1080i50 format of the decompressed 3D video frame may be converted to a 1080p24 format by performing an inverse 2:2 pulldown.

The scaling may be used to convert a video frame from a first resolution to a different resolution. For example, by performing a side-by-side 1080p to top-and-bottom 1080p scaling, a left view 121 at a resolution of 960×1080 pixels may be scaled to a left view 131 at a resolution of 1920×540 pixels, and a right view 122 at a resolution of 960×1080 pixels may be scaled to a right view 132 at a resolution of 1920×540 pixels. The side-by-side (half) 1080p24 format 120c may be converted to the top-and-bottom (half) 1080p24 format 130a. By performing a side-by-side 1080p to frame packing 1080p scaling, a left view 121 at a resolution of 960×1080 pixels may be scaled to a left view 141 at a resolution of 1920×1080 pixels, and a right view 122 at a resolution of 960×1080 pixels may be scaled to a right view 142 at a resolution of 1920×1080 pixels. The side-by-side (half) 1080p24 format 120c may be converted to the frame packing 1080p24 format 140a. By performing a side-by-side 1080p to top-and-bottom 720p scaling, a left view 121 at a resolution of 960×1080 pixels may be scaled to a left view 131 at a resolution of 1280×360 pixels, and a right view 122 at a resolution of 960×1080 pixels may be scaled to a right view 132 at a resolution of 1280×360 pixels. The side-by-side (half) 1080i60 format 120a may be converted to the top-and-bottom (half) 720p60 format 130b by performing the 1080i60 to 1080p60 deinterlacing and the side-by-side 1080p to top-and-bottom 720p scaling.

In an exemplary embodiment of the invention, the 3D video receiver 230 may be operable to determine when the 3D video receiver 230 may be operating in film mode. In instances when the 3D video receiver 230 is operating in the film mode, the 3D video receiver 230 may be operable to convert the decompressed 3D video frame, which may be in the 3D video interlaced format and comprise a 60 Hz field rate, to generate the first 3D video frame, which may be in the first 3D video progressive format and comprise a 24 Hz frame rate, by performing an inverse 3:2 pulldown. The 3D video receiver 230 may be operable to convert the decompressed 3D video frame, which may be in the 3D video interlaced format and comprise a 50 Hz field rate, to generate the first 3D video frame, which may be in the first 3D video progressive format and comprise a 24 Hz frame rate, by performing an inverse 2:2 pulldown. In this regard, for example, the decompressed 3D video frame, which may be in side-by-side (half) 1080i60 format, may be converted by the 3D video receiver 230 to generate the first 3D video frame, which may be in side-by-side (half) 1080p24 format, using an inverse 3:2 pulldown. The decompressed 3D video frame, which may be in side-by-side (half) 1080i50 format, may be converted by the 3D video receiver 230 to generate the first 3D video frame, which may be in side-by-side (half) 1080p24 format, using an inverse 2:2 pulldown. In these instances, the generated first 3D video frame having the side-by-side (half) 1080p24 format may be scaled by the 3D video receiver 230 to generate the second 3D video frame having frame packing 1080p24 format, for example.

In an exemplary embodiment of the invention, the 3D video receiver 230 may be operable to determine when the 3D video receiver 230 may be operating in an EPG mode or in a graphics over video mode.

An EPG provides users with continuously updated menus displaying scheduling information for current and upcoming programs. In the EPG mode, the EPG graphics plane may comprise a video showing current program.

A graphics over video may provide graphics to be placed over 3D video frames. The graphics may be 2D graphics or 3D graphics. For example, the graphics associated with a program manual may be placed over 3D video frames associated with current program.

In instances when the 3D video receiver 230 is operating in an EPG mode or in a graphics over video mode, the 3D video receiver 230 may be operable to blend the generated second 3D video frame, which may be in the second 3D video progressive format, with graphics. In this regard, in instances when the graphics may comprise 3D graphics, a depth of the 3D graphics and/or a depth of the generated second 3D video frame having the second 3D video progressive format may be adjusted coordinately by the 3D video receiver 230 for a blended frame to provide better overall depth of the blended frame. For example, the depth of the generated second 3D video frame having the second 2D video progressive format may be adjusted or pushed back so as to allow the 3D graphics to appear in front of the generated second 3D video frame having the second 3D video progressive format. The depth of the 3D graphics may be adjusted or pushed back so as to allow the generated second 3D video frame having the second 3D video progressive format to appear in front of the 3D graphics, for example.

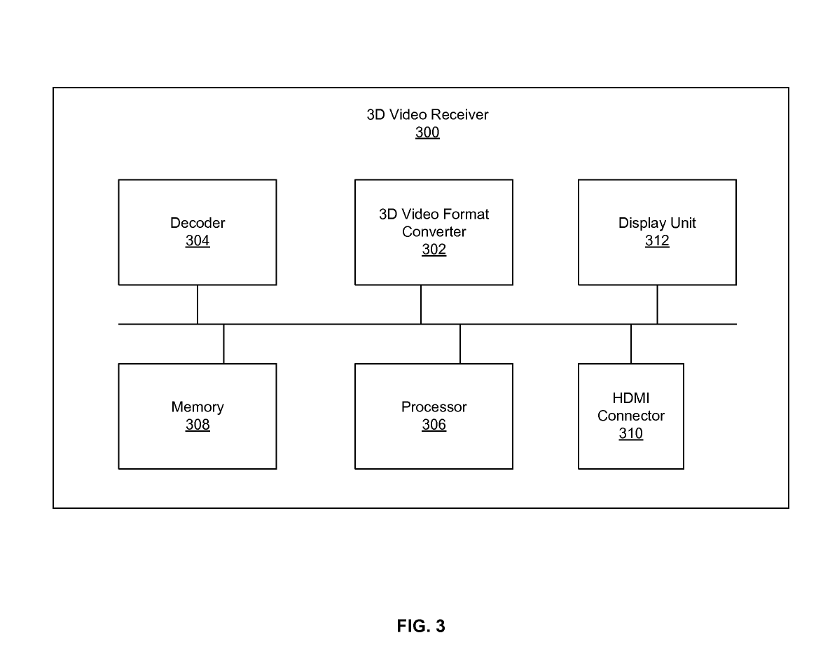

FIG. 3 is a block diagram illustrating an exemplary 3D video receiver that is operable to provide 3D video format conversion with inverse telecine, in accordance with an embodiment of the invention. Referring to FIG. 3, there is shown a 3D video receiver 300. The 3D video receiver 300 may comprise a 3D video format converter 302, a decoder 304, a processor 306, a memory 308, a HDMI connector 110 and a display unit 312.

The 3D video format converter 302 may comprise suitable logic, circuitry, interfaces and/or code that may be operable to receive decompressed 3D video frames from the decoder 304. In an exemplary embodiment of the invention, the 3D video format converter 302 may be operable to also receive decompressed video frames from other 3D video receiver via, for example, the HDMI connector 310. The 3D video format converter 302 may be operable to convert a decompressed 3D video frame from a first 3D video format to a second 3D video format using, for example, inverse pulldown and scaling. The inverse pulldown may comprise inverse 3:2 pulldown and/or inverse 2:2 pulldown.

The decoder 304 may comprise suitable logic, circuitry, interfaces and/or code that may be operable to decode or decompressed compressed 3D video frames which may be received from the 3D video service distributor 210 via the transport stream 220.

The processor 306 may comprise suitable logic, circuitry, interfaces and/or code that may be operable to communicate with the decoder 304, the 3D video format converter 302 and the display unit 312 to perform the decoding functions, the 3D video format conversion functions and/or the display functions of the 3D video receiver 300.

The memory 308 may comprise suitable logic, circuitry, interfaces and/or code that may be operable to store information such as executable instructions and data that may be utilized by the processor 306, the decoder 304, the 3D video format converter 302 and/or the display unit 312 to perform various functions of the 3D video receiver 300.

The HDMI connector 310 may comprise suitable logic, circuitry, interfaces and/or code that may be operable to provide HDMI connection to other 3D video receivers.

The display unit 312 may comprise suitable logic, circuitry, interfaces and/or code that may be operable to display or present 3D video content to users.

In operation, the decoder 304 may be operable to decode or decompressed compressed 3D video frames which may be received from the 3D video service distributor 210 via the transport stream 220. The 3D video format converter 302 may be operable to receive decompressed 3D video frames from the decoder 304. In an exemplary embodiment of the invention, the 3D video format converter 302 may be operable to also receive decompressed video frames from other 3D video receiver via, for example, the HDMI connector 310. The 3D video format converter 302 may be operable to convert a decompressed 3D video frame from a first 3D video format to a second 3D video format using, for example, inverse pulldown and scaling. The inverse pulldown may comprise inverse 3:2 pulldown and/or inverse 2:2 pulldown. In this regard, the first 3D video format, which may be converted to the second 3D video format, may comprise a 3D video interlaced format such as, for example, side-by-side (half) 1080i60 120a and/or side-by-side (half) 1080i50 120b. The second 3D video format may comprise a 3D video progressive format such as, for example, frame packing 1080p24 140a.

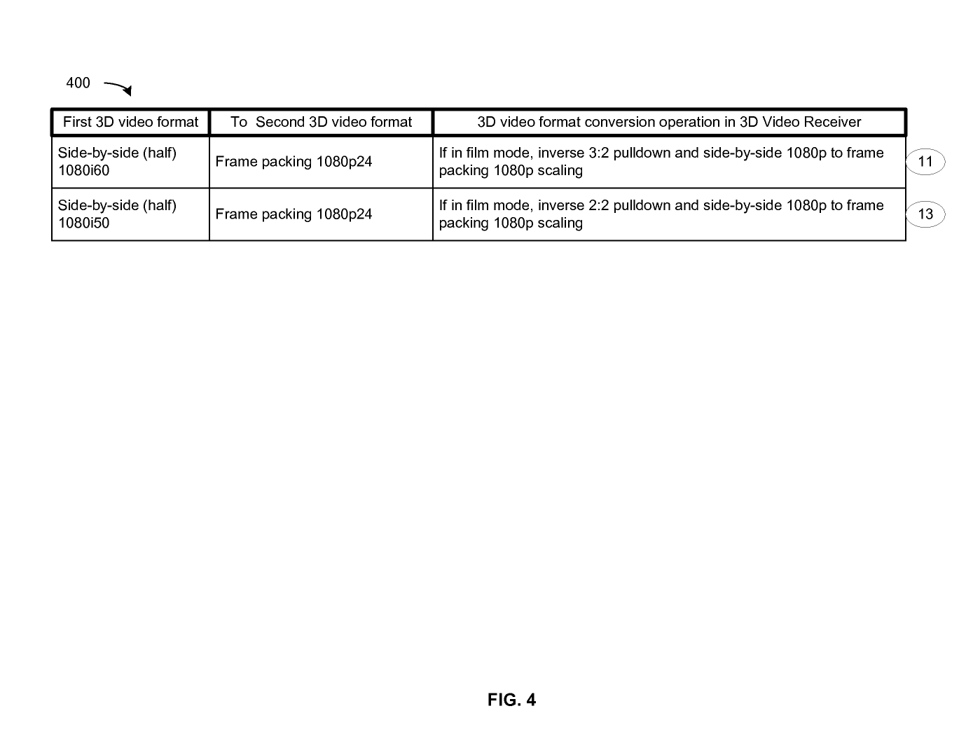

FIG. 4 is an exemplary table that illustrates 3D video format conversion performed by a 3D video receiver, in accordance with an embodiment of the invention. Referring to FIG. 4, there is shown a table 400.

A side-by-side (half) 1080i60 format 120a may be converted to a frame packing 1080p24 format 140a by performing, if in film mode, inverse 3:2 pulldown and side-by-side 1080p to frame packing 1080p scaling as illustrated by the reference label 11.

A side-by-side (half) 1080i50 format 120b may be converted to a frame packing 1080p24 format 140a by performing, if in film mode, inverse 2:2 pulldown and side-by-side 1080p to frame packing 1080p scaling as illustrated by the reference label 13.

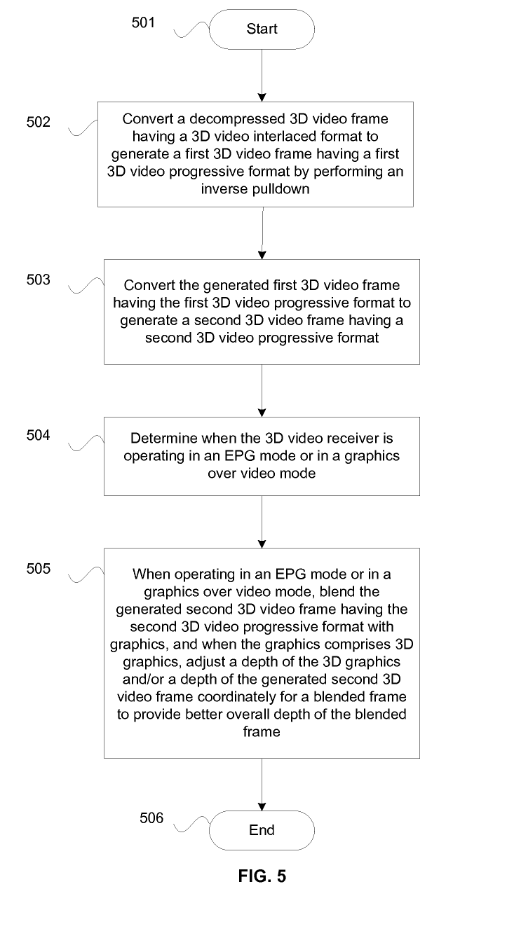

FIG. 5 is a flow chart illustrating exemplary steps for 3D video format conversion, in accordance with an embodiment of the invention. Referring to FIG. 5, the exemplary steps start at step 501. In step 502, a 3D video receiver 230 may be operable to convert a decompressed 3D video frame having a 3D video interlaced format to generate a first 3D video frame having a first 3D video progressive format by performing an inverse pulldown. In step 503, the generated first 3D video frame having the first 3D video progressive format may be converted by the 3D video receiver 230 to generate a second 3D video frame having a second 3D video progressive format. In step 504, the 3D video receiver 230 may be operable to determine when the 3D video receiver 230 may be operating in an EPG mode or in a graphics over video mode. In step 505, when operating in an EPG mode or in a graphics over video mode, the 3D video receiver 230 may be operable to blend the generated second 3D video frame having the second 3D video progressive format with graphics. In instances when the graphics may comprise 3D graphics, a depth of the 3D graphics and/or a depth of the generated second 3D video frame may be adjusted coordinately by the 3D video receiver 230 for a blended frame to provide better overall depth of the blended frame. The exemplary steps may proceed to the end step 506.

In various embodiment of the invention, a 3D video receiver 230 may be operable to convert a decompressed 3D video frame having a 3D video interlaced format to generate a first 3D video frame having a first 3D video progressive format by performing an inverse pulldown. The generated first 3D video frame having the first 3D video progressive format may be converted by the 3D video receiver 230 to generate a second 3D video frame having a second 3D video progressive format. In this regard, the 3D video receiver 230 may be operable to scale the generated first 3D video frame having the first 3D video progressive format to generate the second 3D video frame having the second 3D video progressive format.

In an exemplary embodiment of the invention, the 3D video receiver 230 may be operable to determine when the 3D video receiver 230 may be operating in film mode. In the film mode, the 3D video interlaced format of the decompressed 3D video frame may be derived using a pulldown. In instances when the 3D video receiver 230 is operating in the film mode, the 3D video receiver 230 may be operable to convert the decompressed 3D video frame having the 3D video interlaced format, which may comprise a 60 Hz field rate, to generate the first 3D video frame having the first 3D video progressive format, which may comprise a 24 Hz frame rate, by performing an inverse 3:2 pulldown. The 3D video receiver 230 may be operable to convert the decompressed 3D video frame having the 3D video interlaced format, which may comprise a 50 Hz field rate, to generate the first 3D video frame having the first 3D video progressive format, which may comprise a 24 Hz frame rate, by performing an inverse 2:2 pulldown. In this regard, for example, the decompressed 3D video frame having side-by-side (half) 1080i60 format may be converted by the 3D video receiver 230 to generate the first 3D video frame having side-by-side (half) 1080p24 format by performing an inverse 3:2 pulldown. The decompressed 3D video frame having side-by-side (half) 1080i50 format may be converted by the 3D video receiver 230 to generate the first 3D video frame having side-by-side (half) 1080p24 format by performing an inverse 2:2 pulldown. In such instances, the generated first 3D video frame having the side-by-side (half) 1080p24 format may be scaled by the 3D video receiver 230 to generate the second 3D video frame having frame packing 1080p24 format, for example.

In an exemplary embodiment of the invention, the 3D video receiver 230 may be operable to determine when the 3D video receiver 230 may be operating in an EPG mode or in a graphics over video mode. In instances when the 3D video receiver 230 is operating in the EPG mode or in the graphics over video mode, the generated second 3D video frame having the second 3D video progressive format may be blended with graphics by the 3D video receiver 230. In this regard, in instances when the graphics may comprise 3D graphics, a depth of the 3D graphics and/or a depth of the generated second 3D video frame may be adjusted coordinately by the 3D video receiver 230 for a blended frame to provide better overall depth of the blended frame.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for 3D video format conversion with inverse telecine.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
in a 3-dimensional (3D) video receiver:
converting a decompressed 3D video frame having a 3D video interlaced format to generate a first 3D video frame having a first 3D video progressive format by performing an inverse pulldown; and
converting said generated first 3D video frame having said first 3D video progressive format to generate a second 3D video frame having a second 3D video progressive format.

2. The method according to claim 1, comprising scaling said generated first 3D video frame having said first 3D video progressive format to generate said second 3D video frame having said second 3D video progressive format.

3. The method according to claim 1, comprising determining when said 3D video receiver is operating in film mode.

4. The method according to claim 3, comprising, when said 3D video receiver is operating in said film mode, converting said decompressed 3D video frame having said 3D video interlaced format, which comprises a 60 Hz field rate, to generate said first 3D video frame having said first 3D video progressive format, which comprises a 24 Hz frame rate, by performing an inverse 3:2 pulldown.

5. The method according to claim 3, comprising, when said 3D video receiver is operating in said film mode, converting said decompressed 3D video frame having side-by-side (half) 1080i60 format to generate said first 3D video frame having side-by-side (half) 1080p24 format by performing an inverse 3:2 pulldown.

6. The method according to claim 3, comprising, when said 3D video receiver is operating in said film mode, converting said decompressed 3D video frame having said 3D video interlaced format, which comprises a 50 Hz field rate, to generate said first 3D video frame having said first 3D video progressive format, which comprises a 24 Hz frame rate, by performing an inverse 2:2 pulldown.

7. The method according to claim 3, comprising, when said 3D video receiver is operating in said film mode, converting said decompressed 3D video frame having side-by-side (half) 1080i50 format to generate said first 3D video frame having side-by-side (half) 1080p24 format by performing an inverse 2:2 pulldown.

8. The method according to claim 1, comprising scaling said generated first 3D video frame having side-by-side (half) 1080p24 format to generate said second 3D video frame having frame packing 1080p24 format.

9. The method according to claim 1, comprising determining when said 3D video receiver is operating in an electronic program guide (EPG) mode or in a graphics over video mode.

10. The method according to claim 9, comprising:
blending said generated second 3D video frame having said second 3D video progressive format with graphics when said 3D video receiver is operating in said EPG mode or in said graphics over video mode; and
when said graphics comprises 3D graphics, adjusting a depth of said 3D graphics and/or a depth of said generated second 3D video frame coordinately for a blended frame to provide better overall depth of said blended frame.

11. A system for processing video, the system comprising:
one or more processors and/or circuits for use in a 3-dimensional (3D) video receiver, wherein said one or more processors and/or circuits are operable to:
convert a decompressed 3D video frame having a 3D video interlaced format to generate a first 3D video frame having a first 3D video progressive format by performing an inverse pulldown; and
convert said generated first 3D video frame having said first 3D video progressive format to generate a second 3D video frame having a second 3D video progressive format.

12. The system according to claim 11, wherein said one or more processors and/or circuits are operable to scale said generated first 3D video frame having said first 3D video progressive format to generate said second 3D video frame having said second 3D video progressive format.

13. The system according to claim 11, wherein said one or more processors and/or circuits are operable to determine when said 3D video receiver is operating in film mode.

14. The system according to claim 13, wherein, when said 3D video receiver is operating in said film mode, said one or more processors and/or circuits are operable to convert said decompressed 3D video frame having said 3D video interlaced format, which comprises a 60 Hz field rate, to generate said first 3D video frame having said first 3D video progressive format, which comprises a 24 Hz frame rate, by performing an inverse 3:2 pulldown.

15. The system according to claim 13, wherein, when said 3D video receiver is operating in said film mode, said one or more processors and/or circuits are operable to convert said decompressed 3D video frame having side-by-side (half) 1080i60 format to generate said first 3D video frame having side-by-side (half) 1080p24 format by performing an inverse 3:2 pulldown.

16. The system according to claim 13, wherein, when said 3D video receiver is operating in said film mode, said one or more processors and/or circuits are operable to convert said decompressed 3D video frame having said 3D video interlaced format, which comprises a 50 Hz field rate, to generate said first 3D video frame having said first 3D video progressive format, which comprises a 24 Hz frame rate, by performing an inverse 2:2 pulldown.

17. The system according to claim 13, wherein, when said 3D video receiver is operating in said film mode, said one or more processors and/or circuits are operable to converting said decompressed 3D video frame having side-by-side (half) 1080i50 format to generate said first 3D video frame having side-by-side (half) 1080p24 format by performing an inverse 2:2 pulldown.

18. The system according to claim 11, wherein said one or more processors and/or circuits are operable to scale said generated first 3D video frame having side-by-side (half) 1080p24 format to generate said second 3D video frame having frame packing 1080p24 format.

19. The system according to claim 11, wherein said one or more processors and/or circuits are operable to determine when said 3D video receiver is operating in an electronic program guide (EPG) mode or in a graphics over video mode.

20. The system according to claim 19, wherein said one or more processors and/or circuits are operable to:
blend said generated second 3D video frame having said second 3D video progressive format with graphics when said 3D video receiver is operating in said EPG mode or in said graphics over video mode; and
when said graphics comprises 3D graphics, adjust a depth of said 3D graphics and/or a depth of said generated second 3D video frame coordinately for a blended frame to provide better overall depth of said blended frame.
